(19) United States
(12) Patent Application Publication
(10) Pub. No.: US 2017/0270718 A1
(43) Pub. Date: Sep. 21, 2017

(54) Method of Determining Mileage Rate for a Motor Vehicle

(71) Applicant: Intellicasting LLC, Mason, OH (US)

(72) Inventor: Brian Schaaf, Mason, OH (US)

(21) Appl. No.: 15/458,349

(22) Filed: Mar. 14, 2017

Related U.S. Application Data
(60) Provisional application No. 62/308,307, filed on Mar. 15, 2016.

(51) Int. Cl. G07B 13/06; G06Q 20/40

(52) U.S. Cl. CPC G07B 13/06; G06Q 20/405

(57) ABSTRACT

The present method of determining a payment for a work-related use of a vehicle in an travel area basically comprises (1) obtaining identifying information about the vehicle, said information including the following particulars: make, model, year, mileage, and condition; (2) providing the vehicle particulars to an exogenous source wherein data concerning a group of vehicles having particulars similar to the subject vehicle is maintained, said data being based upon use of the group of vehicles over a stated period of time and a stated mileage; (3) selecting cost information concerning the group of vehicles, said cost information including at least the following factors: depreciation, insurance, repairs, maintenance, state license fees, and fuel, said information being reflective of the travel area; (4) determining a cost per mile for each of the selected factors; (5) adding the cost per mile determinations to obtain a per mile payment rate for the vehicle; and (6) determining the payment by multiplying the per mile payment rate by the number of miles the vehicle travels during the work-related use for a selected period of time.

### RELATED APPLICATION

The present non-provisional application is based upon and claims the priority of U.S. Provisional Application No. 62/308,307 filed Mar. 15, 2016.

### TECHNICAL FIELD

The present invention relates to methods of synthesizing data specific to selected motor vehicles and exogenous data concerning a group of similar vehicles, and more particularly to methods of determining arithmetic values based upon that synthesis.

### BACKGROUND

Currently many delivery-based business services such as restaurants reimburse their delivery drivers for the use of their vehicles by a mileage rate. In many situations, the federal government requires the business owner to use a standard mileage rate or mileage rate equivalent as a means of reimbursement for use of an employee's vehicle. However, under some circumstances, the business owner may be permitted to use a lower, actual rate based upon allowable expenses, if the owner maintains adequate records or other sufficient evidence. Most restaurant owners or companies do not have the means to calculate an actual mileage rate for a particular driver and his/her vehicle.

### SUMMARY

The present method of determining a payment amount for a work-related use of a vehicle in an travel area basically comprises obtaining identifying information about the vehicle, providing the vehicle information to a third party or exogenous source, selecting cost information relevant to the vehicle from the exogenous source, and determining a cost per mile for each of a group of selected factors.

Preferably, the identifying information includes the make, model, year, mileage, and condition of the vehicle. The cost information from the exogenous source is based upon use of a group of vehicles that are similar to the subject vehicle over a stated period of time and mileage. The cost information is reflective of the travel area and includes depreciation, insurance, repairs, maintenance, state license fees, and fuel.

### BRIEF DESCRIPTION OF THE DRAWINGS

FIG. 1 is a diagram of the manner in which information may be obtained and organized;

FIG. 2 is a flowchart of the steps involved in an exemplary form of the present method;

FIG. 3 illustrates identifying information that may be gathered from the drivers and/or store manager about the vehicles;

FIG. 4 illustrates additional driver-based vehicle information, as well as data that may be gathered from a third party source based upon the drivers' information;

FIG. 5 illustrates vehicle information and cost information on a per mile basis;

FIG. 6 illustrates a reimbursement rate analysis for a particular vehicle; and

FIG. 7 illustrates the aggregation of data to show the price per mile based upon each business location.

### DESCRIPTION OF AN EXEMPLARY EMBODIMENT

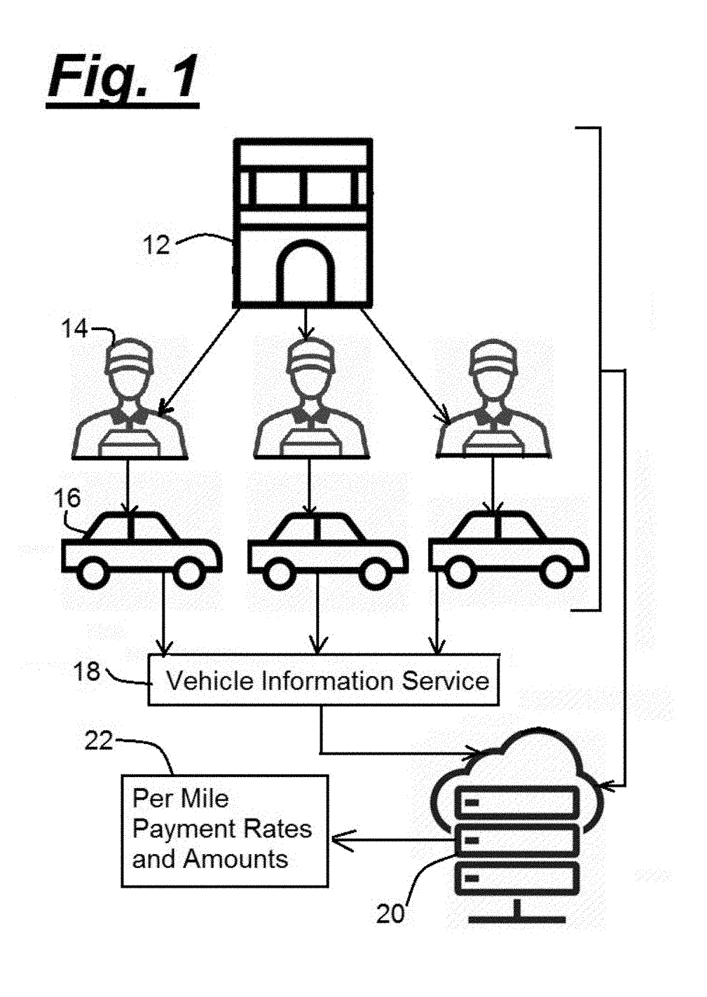

As illustrated in FIG. 1, a basic organization structure for determining driver reimbursement contemplates one or more stores 12 from which goods such as prepared food are distributed to purchasers (not shown) by drivers 14 using their own vehicles 16. As described in some detail herein, the drivers 14 are reimbursed for the work-related use of their vehicles 16 by providing particular or identifying information about their store 12, themselves and their vehicles, to which is added cost related information about a group of vehicles resembling each of the drivers' vehicles from an exogenous or third party vehicle information source 18. Inputs from the store 12, drivers 14 and third party source 18 may be received by an Interweb based service 20 through which the inputs are manipulated to derive per mile reimbursement rates and payment amounts 22.

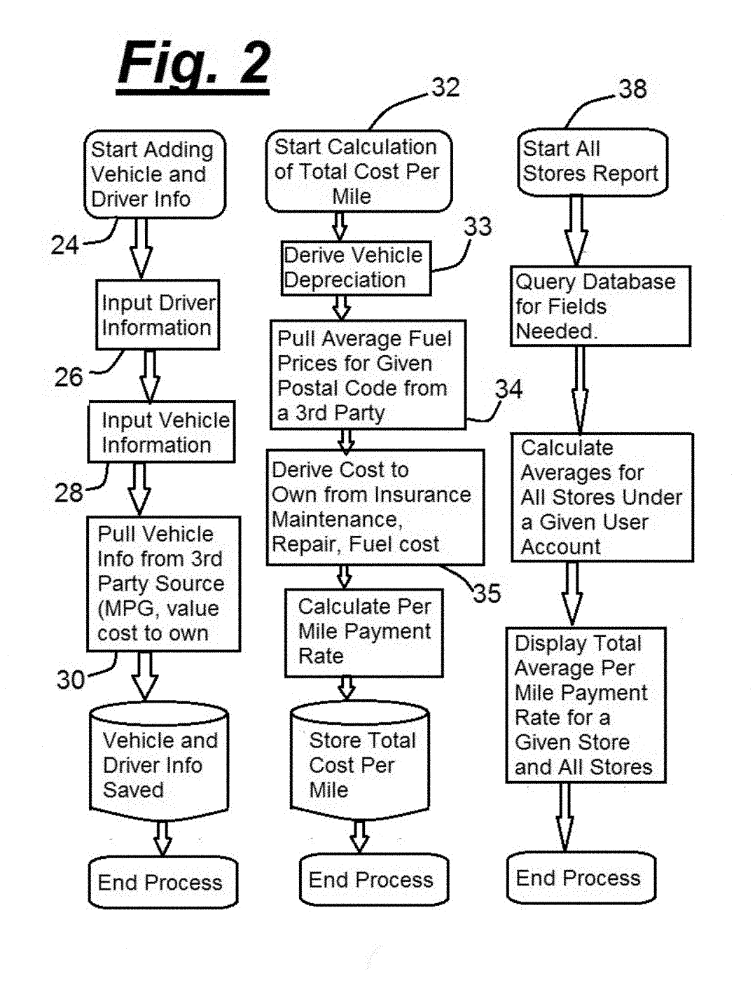

As illustrated in FIG. 2, the rate/reimbursement determination process, may be characterized in a flowchart having three groups or categories of steps. The first group 24 involves data inputs about a driver associated with a store 26, the driver's vehicle 28 and third party cost information 30. The second group 32 involves cost per mile determinations based upon the vehicle, driver and third party inputs from the first group. The cost per mile determinations include vehicle depreciation 33, fuel prices for the travel area 34, insurance, maintenance and repair cost 35. The third group 38 involve multi-store comparative analysis of vehicle costs.

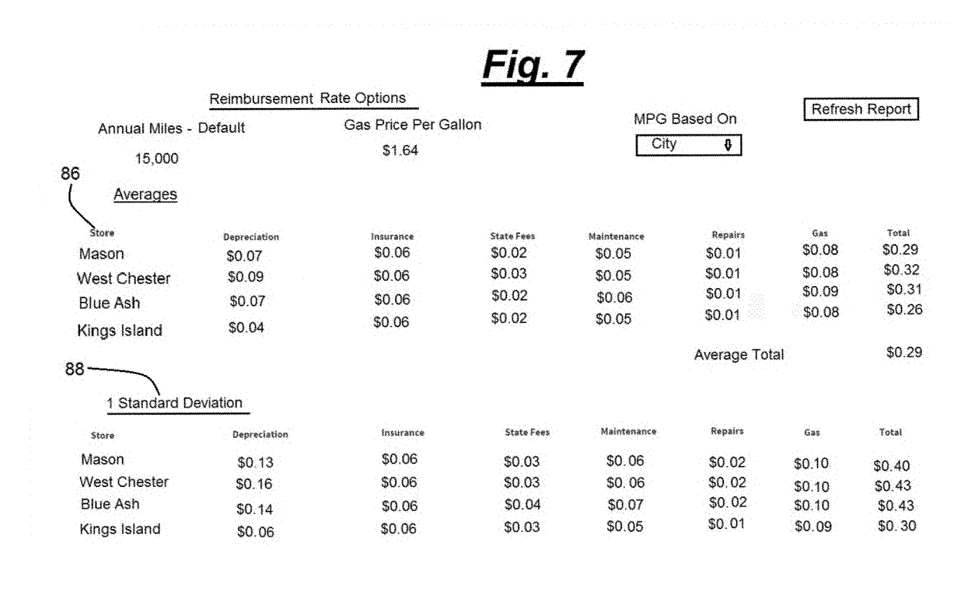

As illustrated in FIG. 3, some of the basic driver/vehicle inputs are the drivers' name 40, the makes and models of their vehicles 42, the date the vehicles began to be used for work related purposes 44, and the date that the vehicles' total values were determined by consulting a third party or exogenous source such as Edmonds.com, Inc. or Kelley Blue Book Co. 46.

As illustrated in FIG. 4, additional information may be obtained concerning the vehicles such as the odometer reading 40 on the in-service date 44, the driver's zip code 50, which is useful in travel area determinations, as well as the vehicle's trim package 52 and condition 54. Based upon the vehicle information, the exogenous or third party source can provide a valuation or fair market value 56, the vehicle's miles per gallon rating 58, auto insurance costs 60, state license fees 62, maintenance 64, and repairs 66. Some of the foregoing are based upon use of the vehicle over a specified distance, such as 15,000 miles, and a specified time period, such as 5 years. The third party data may be updated or revised by the user or business owner in case the data being supplied by the third party source is deemed to be inaccurate. Therefore, if alternative information or evidence is supplied that backs up the costs associated with the vehicle, it can be stored, and the fields can be manually updated to the new amounts. In this situation, the third party source serves as a default.

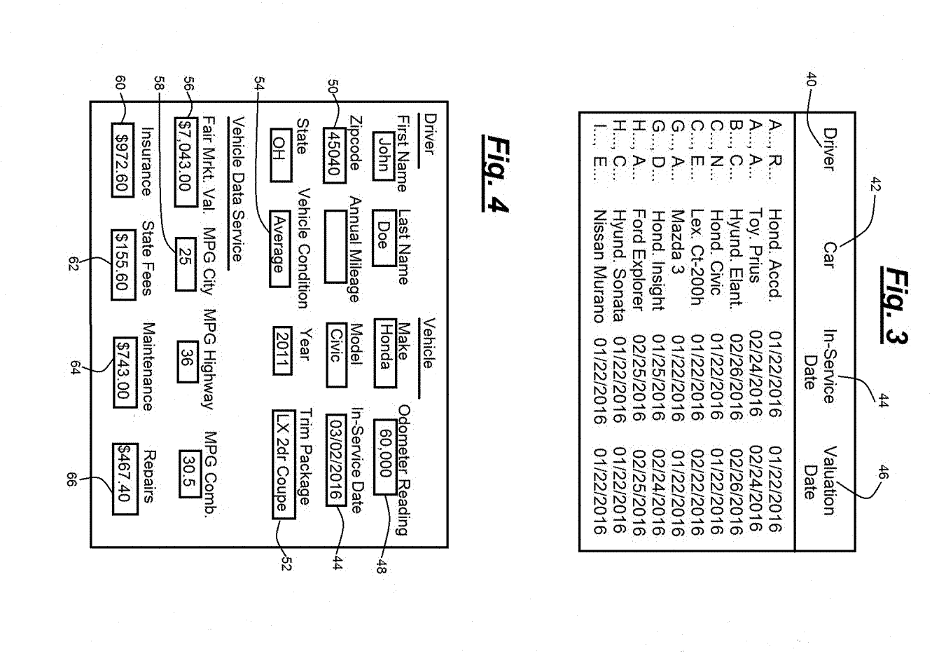

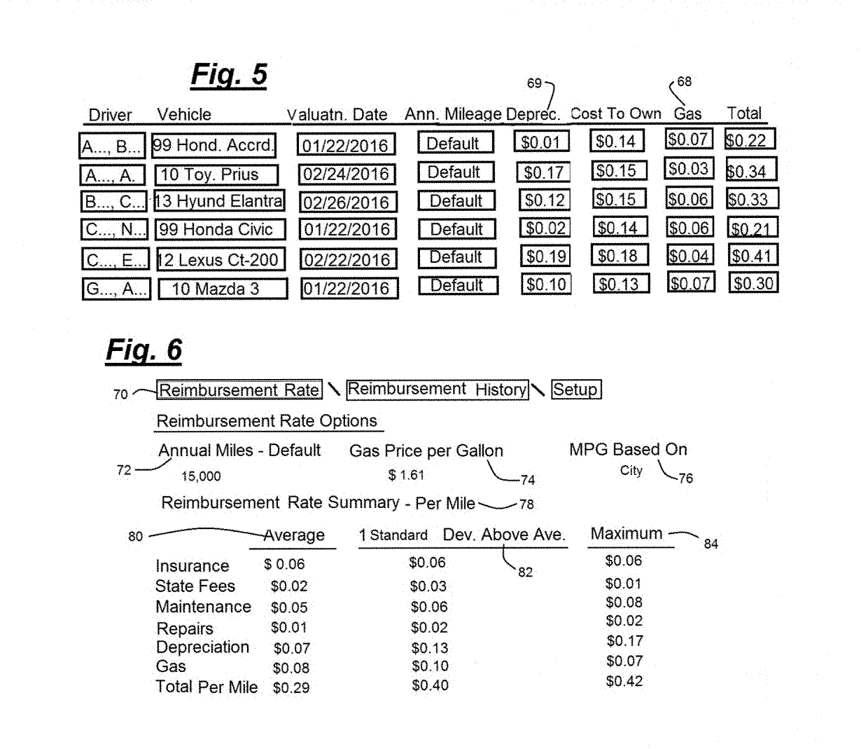

As illustrated in FIG. 5, the driver and third party data may be organized as a fleet of vehicles based upon the location of a particular store or other driver-based business. The price of gasoline per gallon may be obtained from a third party data source like Gas Price Watch or Gas Buddy based upon the zip code of the business location, and a determination of the per mile cost of gasoline 68 using the MPG factor 58 (FIG. 4). Depreciation 69 may be quantified on a per mile basis using third party data concerning valuation and/or straight line deprecation calculated from third party in service period and mileage estimate.

As illustrated in FIG. 6, a reimbursement rate analysis 70 may include factors such as annual mileage (based on the third party information) 72, gas price per gallon 74, an indication of whether the MPG is based on city, highway or a combined average 76 and an indication of whether the reimbursement rate is per mile 78, or some multiple thereof. At this point, the specific cost to own factors, namely, insurance, state fees, maintenance, repairs, gas, and depreciation may be averaged on a per mile basis.80, standard deviation for these costs may be calculated 82, and a maximum per mile cost set 84.

As illustrated in FIG. 7, the average price per mile for insurance, state fees, maintenance, repairs, deprecation, gas, and total per mile for the entire fleet based upon store location 86 may then be calculated and displayed. Preferably, one standard deviation 88 above the average for each sub category may also be calculated. In addition, the maximum price per mile for each of the individual sub categories, as well as the highest paid price per mile for the highest paid vehicle may also be displayed (not shown)

The present system can look back to create reports specific to a particular date and driver to substantiate using actual allowable expense amounts if the business owner maintains adequate records or other sufficient evidence.

1. A method of determining a payment factor for a work-related use of a vehicle in an travel area, said method comprising the steps of: obtaining identifying information about the vehicle; providing the identifying information to a third party source; receiving cost information relevant to the vehicle from the third party source; and determining a cost per mile for each of a group of selected factors.

2. The method of determining a payment factor according to claim 1, and further comprising the step of adding the cost per mile for each of the factors to obtain a per mile payment rate.

3. The method of determining a payment factor according to claim 2, and further comprising the step of multiplying the per mile payment rate by the number of miles the vehicle travels to obtain the payment amount for a selected period of time.

4. The method of determining a payment factor according to claim 1, wherein the identifying information includes the make, model, year, mileage, and condition of the vehicle.

5. The method of determining a payment factor according to claim 1, wherein the cost information from the third party source is based upon use of a group of vehicles having particulars similar to the subject vehicle over a stated period of time and mileage.

6. The method of determining a payment factor according to claim 5, wherein the cost information is reflective of the travel area and includes depreciation, insurance, repairs, maintenance, state license fees, and fuel.

7. The method of determining a payment factor according to claim 6, wherein any of the cost information from the third party source may be changed by an authorized user.

8. A method of determining a payment factor for a work-related use of a vehicle in an travel area, said method comprising:
Obtaining identifying information about the vehicle, said information including the following particulars: make, model, year, mileage, and condition;
Providing the vehicle particulars to a third party source wherein data concerning a group of vehicles having particulars similar to the subject vehicle is maintained, said data being based upon use of the group of vehicles over a stated period of time and a stated mileage;
Receiving cost information concerning the group of vehicles from the third party source, said cost information including at least the following factors: depreciation, insurance, repairs, maintenance, state license fees, and fuel, said information being reflective of the travel area;
Determining a cost per mile for each of the selected factors;
Adding the cost per mile determinations to obtain a per mile payment rate for the vehicle; and
Determining a payment amount by multiplying the per mile payment rate by the number of miles the vehicle travels during the work-related use for a selected period of time.
